(19) United States
(12) Patent Application Publication
(10) Pub. No.: US 2026/0257506 A1
(43) Pub. Date: Sep. 3, 2026

(54) IMAGE RECORDING APPARATUS

(71) Applicant: BROTHER KOGYO KABUSHIKI KAISHA, Nagoya (JP)

(72) Inventor: TAICHI SHIRONO, Nagoya (JP)

(73) Assignee: BROTHER KOGYO KABUSHIKI KAISHA, Nagoya (JP)

(21) Appl. No.: 19/549,813

(22) Filed: Feb. 25, 2026

(30) Foreign Application Priority Data
Feb. 28, 2025 (JP) 2025-030939

(51) Int. Cl. B41J 29/393; B41J 25/00; B41J 29/13

(52) U.S. Cl. CPC B41J 29/393; B41J 25/005; B41J 29/13

(57) ABSTRACT

An image recording apparatus includes: a head unit including a head, and a control board having a controller; a support part detachably supporting the head unit; a wiring member; a cover; a first connector supported on the control board; and a second connector. The second connector is connected to the wiring member and is detachable from the first connector in a first direction crossing a surface, of the control board, on which the first connector is supported. The cover is configured to support the second connector. In a state where the second connector is attached to the first connector, the cover is configured to cover at least a part of the control board.

### REFERENCE TO RELATED APPLICATIONS

This application claims priority from Japanese Patent Application No. 2025-030939 filed on Feb. 28, 2025. The entire content of the priority application is incorporated herein by reference.

### BACKGROUND ART

The present disclosure relates to an image recording apparatus including a head which records an image.

A certain known ink-jet printer includes a carriage, a body which is attachable to and detachable from the carriage, a printed circuit board, a connector, and a flat cable. The body includes a recording head, and the printed circuit board is fixed to the upper surface of the body. The connector has a connector body fixed to the upper surface of the printed circuit board, and an upper cover body rotatable with respect to the connector body. The flat cable is connected to the connector in response to the upper cover body being rotated so as to close the connector body in a state where contact points of the flat cable are disposed on the connector body. The flat cable is electrically connected to the printed circuit board via the connector.

### SUMMARY

In the known ink-jet printer as described above, detaching the body including the recording head from the carriage and attaching the body including the recording head to the carriage requires an operation of detaching the flat cable from the connector and an operation of attaching the flat cable to the connector. In the detaching operation, a user manually rotates the upper cover body of the connector so as to open the connector body, and then removes the flat cable from the body. In the attaching operation, the user manually rotates the upper cover of the connector so as to close the connector body in a state where the contact points of the flat cable are disposed on the connector body of the connector. In such a manner, in both the detaching and attaching operations, consequently, the user directly touches the connector by hand. The connector is fixed to the printed circuit board. Therefore, in the configuration of the known ink-jet printer, when the user detaches or attaches the flat cable from or to the body including the recording head, the hand or the user is likely to come into contact with the printed circuit board, and, consequently, with an electronic component and/or a terminal included in the printed circuit board. As a result, for example, the printed circuit board is likely to be damaged.

In view of the above-described situation, the present disclosure aims to provide an image recording apparatus contributing to the prevention of the hand of user from coming into contact with the control board during the operations of detaching and attaching a wiring member to and from a head unit.

An image recording apparatus according to the present disclosure includes: a head unit including a head, and a control board having a controller configured to control the head; a support part configured to detachably support the head unit; a wiring member; a cover; a first connector supported on the control board; and a second connector connected to the wiring member. The second connector is detachable from the first connector in a first direction crossing a surface, of the control board, on which the first connector is supported. The cover is configured to support the second connector. In a state where the second connector is attached to the first connector, the cover is configured to cover at least a part of the control board.

The image recording apparatus according to the present disclosure is configured so that, when the user detaches the head unit from the support part, or when the user attaches the head unit to the support part, the user is able to hold the cover by hand to detach or attach the second connector from or to the first connector. Accordingly, in the operation of detaching and attaching the wiring member from and to the head unit, the hand of the user is prevented from coming into contact with the control board.

### BRIEF DESCRIPTION OF DRAWINGS

FIG. 1 is a schematic diagram illustrating the configuration of a printer according to an embodiment of the present disclosure.

FIG. 2 is a perspective view of a head unit illustrated in FIG. 1.

FIG. 3 is a block diagram illustrating the electrical configuration of the printer.

FIG. 4A is a perspective view of the head unit illustrated in FIG. 2 in a state where a cover, a wiring member, and an ink tube are detached from the head unit, and FIG. 4B is a perspective view of the head unit illustrated in FIG. 4A as viewed from obliquely below.

FIG. 5 is a schematic cross-sectional view of a rear part of the head unit, taken along a vertical plane orthogonal to the left-right direction.

FIG. 6A is a plan view of a joint member, and FIG. 6B is a view illustrating the joint member illustrated in FIG. 6A in a state where the joint member is pressed by a retaining member.

FIG. 7 is a plan view of a head.

FIG. 8A is a perspective view of a connector supported on a control board, and a guide member; and FIG. 8B is a cross-sectional view of main parts in a state where the connector supported on the control board and a connector supported on a relay board are mated with each other.

FIG. 9 is a cross-sectional view taken along a IX-IX line illustrated in FIG. 4.

FIG. 10A is a plan view of the retaining member, and FIG. 10B is a cross-sectional view taken along a X-X line illustrated in FIG. 10A.

FIG. 11A is a perspective view of a belt-retained part, and FIG. 11B is a perspective view of the belt-retained part illustrated in FIG. 11A, as viewed obliquely below.

FIG. 12A is a perspective view of the cover, as viewed from obliquely below, and FIG. 12B is a bottom view of the cover.

FIG. 13A is a perspective view of the head unit illustrated in FIG. 4A, in a state where the retaining member is in a release state, and FIG. 13B is a perspective view of the head unit illustrated in FIG. 13A, as viewed from obliquely below.

FIG. 14 is a plan view illustrating a situation in which the head unit is detached from a moving mechanism illustrated in FIG. 1.

### DESCRIPTION

### Overall Configuration of Printer

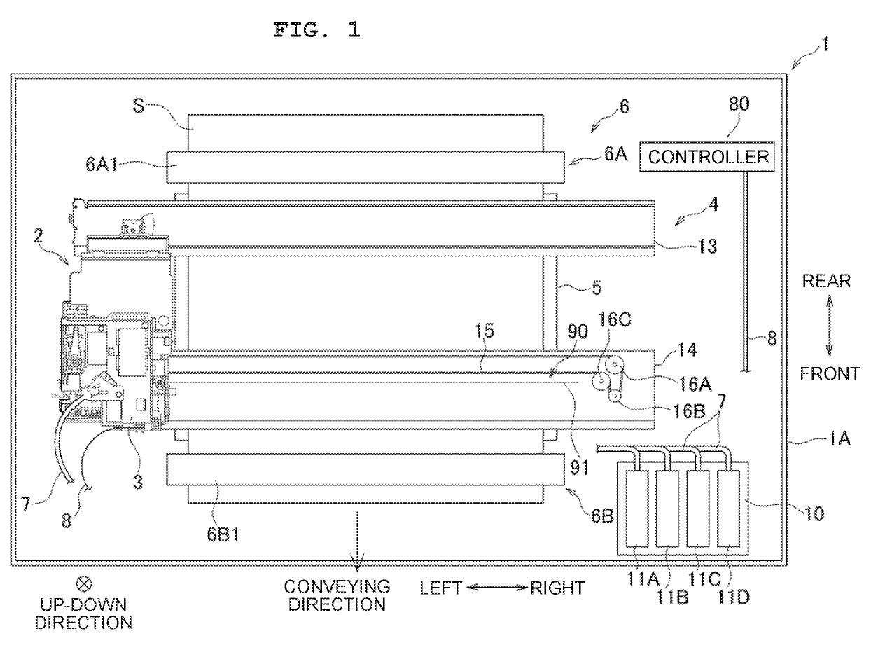

As illustrated in FIGS. 1, 2 and 12, a printer 1 according to the present embodiment includes a head unit 2, a cover 3, a moving mechanism 4, a platen 5, a conveyor 6, four ink tubes 7, a wiring member 8, a relay board 9, a controller 80, and a body 1A. As illustrated in FIG. 1, the body 1A accommodates the above-described components of the printer 1, including, for example, the head unit 2, the cover 3, the moving mechanism 4, the platen 5, and the conveyor 6.

The printer 1 is installed for use in a state illustrated in FIG. 1. The lower part in FIG. 1 is the front, and the upper part in FIG. 1 is the rear. A direction orthogonal to the sheet surface of FIG. 1 is the up-down direction. Further, the left-right direction is a direction in which the printer 1 is viewed from the front. The printer 1 corresponds to the "image recording apparatus" of the present disclosure.

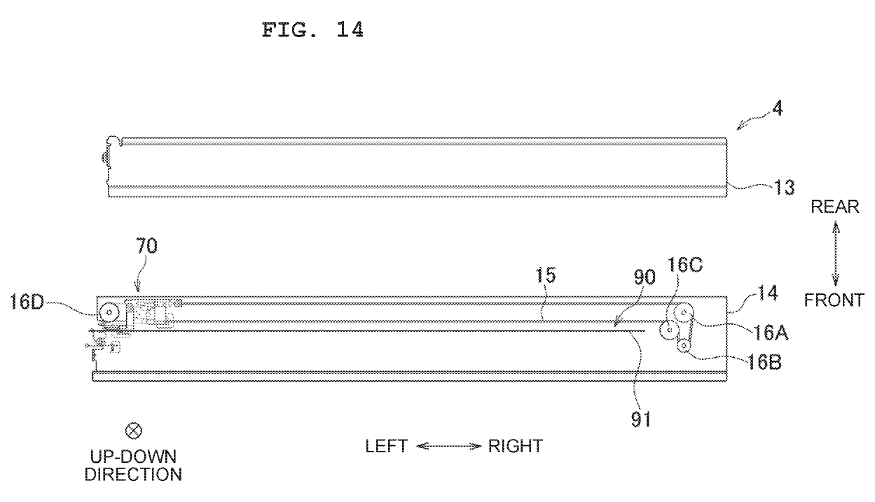

As illustrated in FIGS. 1 and 14, the moving mechanism 4 includes two guide rails 13 and 14, a belt 15, and four pulleys 16A to 16D. The two guide rails 13 and 14 extend parallel to each other along the left-right direction. Further, the two guide rails 13 and 14 are spaced apart from each other in the front-rear direction.

The four pulleys 16A to 16D are disposed on the upper surface of the guide rail 14. Among the four pulleys 16A to 16D, three pulleys 16A to 16C are disposed at a right end part of the guide rail 14. The pulley 16D as the remaining one of the four pulleys 4A to 4D is disposed at a left end part of the guide rail 14, as illustrated in FIG. 14. The belt 15 has an annular shape, and is wound around the four pulleys 16A to 16D.

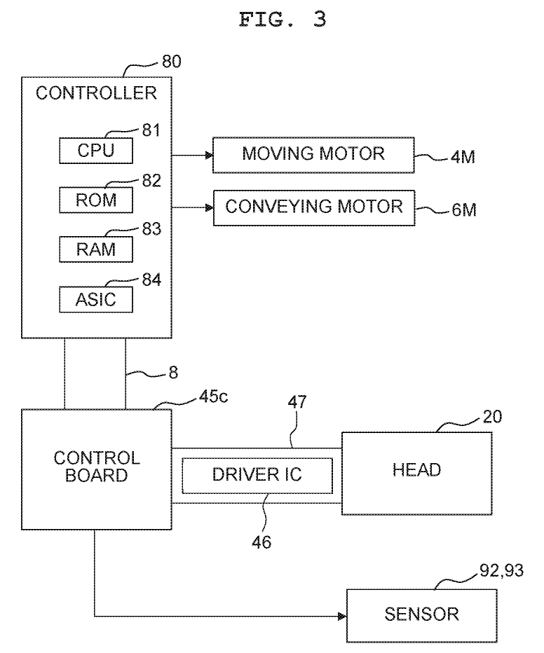

Further, the moving mechanism 4 has a belt-retained part 70, as illustrated in FIG. 14. The belt-retained part 70 is retained by the belt 15, at a location, in a space defined by the belt 15, which is between the two pulleys 16C and 16D. Furthermore, the moving mechanism 4 has a moving motor 4M, as illustrated in FIG. 3. The moving motor 4M is driven under the control of the controller 80 to rotate the pulley 16B. This causes the belt 15 to run and causes the belt-retained part 70 to move in the left-right direction.

The head unit 2 is detachably attached to the belt-retained part 70. As a result, the belt-retained part 70 moves in the left-right direction to thereby also cause the head unit 2 to move in the left-right direction. The left-right direction is a scanning direction of the head unit 2. The two guide rails 13 and 14 and the belt-retained part 70 correspond to the "support part" of the present disclosure.

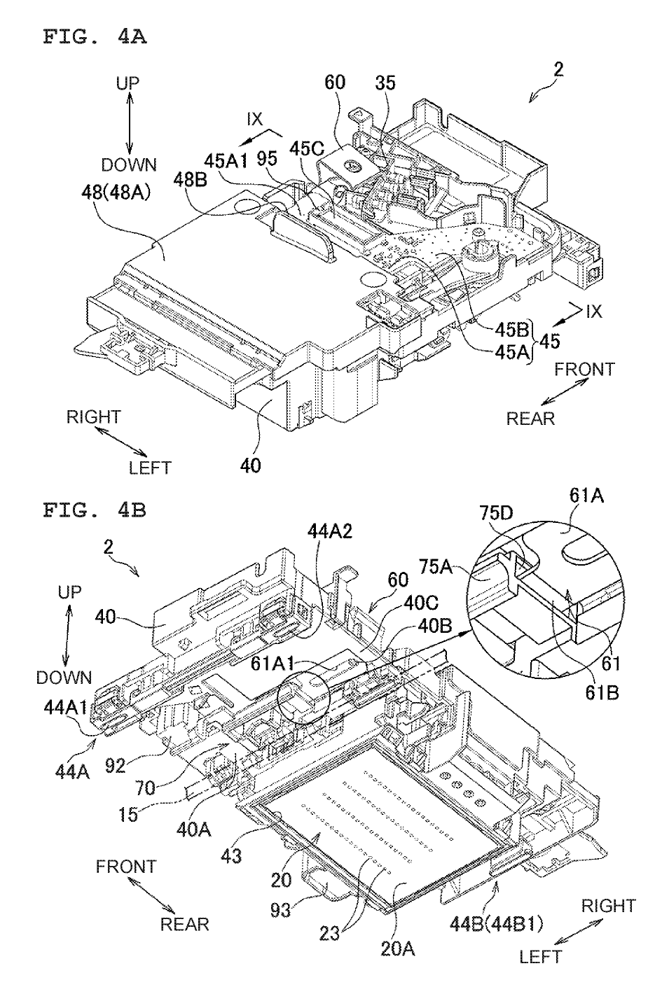

The head unit 2 has a head 20 as illustrated in FIG. 4B. The head 20 has a nozzle surface 20A in which a plurality of nozzles 23 are defined. The nozzle surface 20A is the lower surface of the head 20. The details of the head unit 2 including the head 20 will be described later.

The platen 5 extends in the left-right direction and supports a sheet S, which is paper sheet, from below, as illustrated in FIG. 1. The width in the left-right direction of the platen 5 is larger than the width in the left-right direction of the sheet S. The platen 5 is disposed below the head 20 to be capable of facing the plurality of nozzles 23.

The conveyor 6 has a first conveying roller part 6A and a second conveying roller part 6B. The first conveying roller part 6A is disposed to the rear of the platen 5. The first conveying roller part 6A has two conveying rollers 6A1. The two conveying rollers 6A1 are disposed side by side in the up-down direction, in a state where the rotation axes of the two conveying rollers 6A1 are parallel to the left-right direction, so that the sheet S can be held between the two conveying rollers 6A1.

The second conveying roller part 6B is disposed to the front of the platen 5. The second conveying roller part 6B has two conveying rollers 6B1. The two conveying rollers 6B1 are disposed side by side in the up-down direction, in a state where the rotation axes of the two conveying rollers 6B1 are parallel to the left-right direction, so that the sheet S can be held between the two conveying rollers 6B1.

The conveyor 6 has a conveying motor 6M, as illustrated in FIG. 3. The conveying motor 6M is driven under the control of the controller 80 to thereby rotate the conveying rollers 6A1 and 6B1 via a non-illustrated transmission mechanism. As a result, the sheet S is conveyed in a conveying direction from the rear toward the front.

The printer 1 includes a cartridge holder 10, as illustrated in FIG. 1. Four ink cartridges 11A to 11D are detachably attached to the cartridge holder 10. The four ink cartridges 11A to 11D are disposed side by side in the left-right direction and store, in order from the leftmost cartridge 11A to the rightmost cartridge 11D, yellow, cyan, magenta, and black inks, respectively.

One end of each of the four ink tubes 7 is connected to a corresponding one of the four ink cartridges 11A to 11D attached to the cartridge holder 10. The other end of each of the four ink tubes 7 is connected to a joint member 35 (see FIG. 4A) included in the head unit 2. The four ink tubes 7 are flexible and extend long in the left-right direction. Further, the four ink tubes 7 are disposed in the body 1A so that the four ink tubes 7 are capable of following the head unit 2 as the head unit 2 moves in the scanning direction.

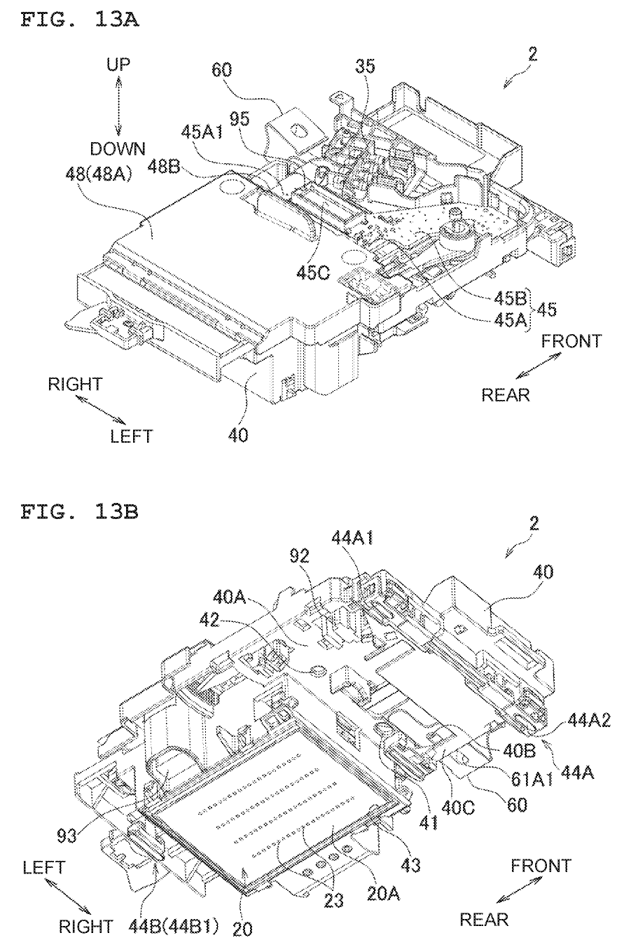

The wiring member 8 connects a control board 45 included in the head unit 2 to the controller 80, as illustrated in FIGS. 1 and 13A. The wiring member 8 is flexible and extends long from the left toward the right in a front part in the body 1A. With this, the wiring member 8 is able to follow the head unit 2 as the head unit 2 moves in the scanning direction. Further, the wiring member 8 is routed in a complicated manner from the front to the rear in the body 1A. In the present embodiment, a flexible flat cable is used as the wiring member 8. Note that the wiring member 8 may be constructed of another wiring member, different from the flexible flat cable, as long as the another wiring member is flexible.

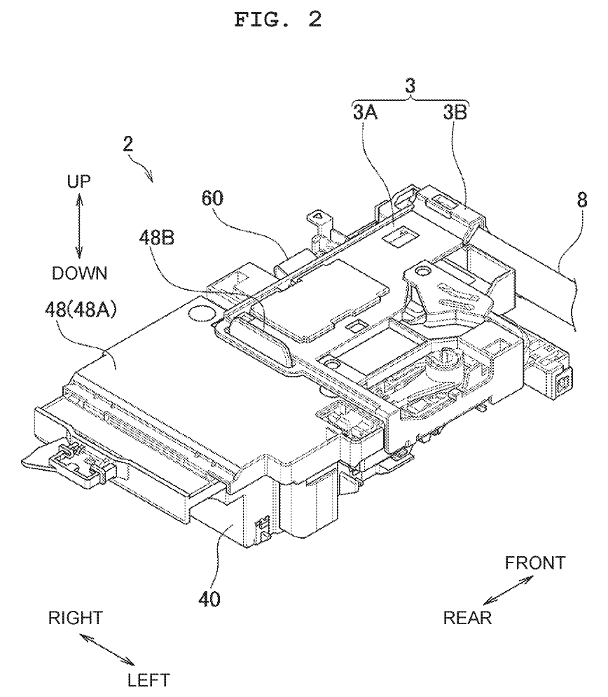

As illustrated in FIG. 2, the cover 3 is detachably disposed to cover the head unit 2, from a center part to the front part of the head unit 2 in the front-rear direction. The cover 3 holds a relay board 9, which will be described later, and the wiring member 8 which is connected to the relay board 9. Further, the cover 3 covers a connection location at which the wiring member 8 and the control board 45 are connected, and a connection location at which the four ink tubes 7 and the joint member 35 are connected. The details of the cover 3 will be described later.

The printer 1 has a linear encoder 90, as illustrated in FIG. 1. The linear encoder 90 has an encoder strip 91 and a sensor 92 which will be described later. The encoder strip 91 is disposed in the guide rail 14 and extends in the left-right direction along the belt 15. The encoder strip 91 has a scale constructed of a light-transmitting part and a light-shielding part.

The sensor 92 is a transmissive photo sensor and is attached to a carriage 40, which will be described later, via the control board 45, as illustrated in FIGS. 4A and 4B. The sensor 92 is disposed, in the carriage 40, at a position at which the sensor 92 faces the encoder strip 91 in the up-down direction. The sensor 92 is capable of optically reading the scale of the encoder strip 91 and of outputting a signal indicating the result of the reading to the controller 80.

The printer 1 has a sensor 93. The sensor 93 is a reflective photo sensor and is attached to the carriage 40. The sensor 93 is disposed to the left of the head 20 in the carriage 40 so that the sensor 93 is capable of detecting the sheet S on the platen 5. The sensor 93 detects the difference between the color of the platen 5 and the color of the sheet S while the carriage 40 is moving in the left-right direction, and outputs a detection signal of the difference to the controller 80. The controller 80 detects the width in the left-right direction of the sheet S based on the detection signal from the sensor 93.

### Electrical Configuration of Printer

Next, the electrical configuration of the printer 1 will be described. The operation of the printer 1 is controlled by the controller 80. As illustrated in FIG. 3, the controller 80 is constructed, for example, of a CPU 81, a ROM 82, a RAM 83, and an ASIC 84. The controller 80 controls the operation of each of the moving motor 4M, the conveying motor 6M, and the head 20. The head 20 is electrically connected to the controller 80 via the wiring member 8, the control board 45, and a COF 47. The controller 80 controls a driver IC 46 mounted on the COF 47 to thereby control the head 20.

Further, the sensor 92 is electrically connected to the controller 80 via the control board 45 and the wiring member 8. The controller 80 derives the position in the left-right direction of the head 20 based on a signal from the sensor 92.

Furthermore, the sensor 93 is electrically connected to the controller 80 via the control board 45 and the wiring member 8. The controller 80 derives the width in the left-right direction of the sheet S based on the detection signal from the sensor 93.

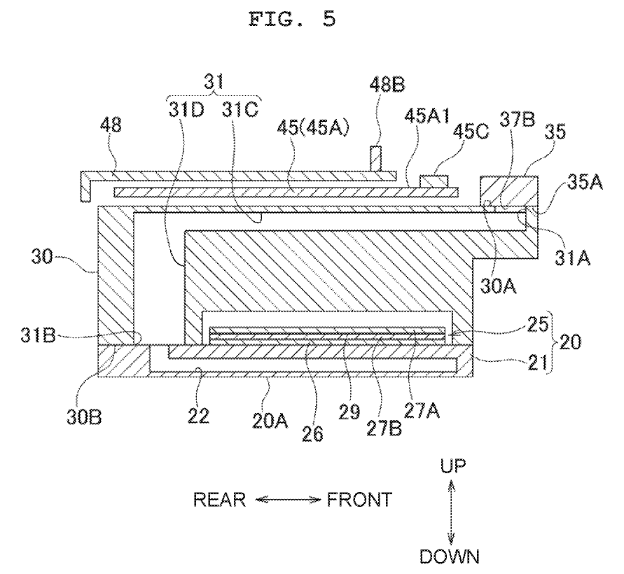

Next, the head unit 2 will be described in detail. The head unit 2 has the head 20, a sub-tank 30, the joint member 35, the carriage 40, the control board 45, and a head cover 48, as illustrated in FIGS. 4A, 4B, and 5. The carriage 40 is a box-shaped frame which is open upward and in which the head 20 and the sub-tank 30 are accommodated. The head 20 and the sub-tank 30 accommodated in the carriage 40 are non-detachably fixed to the carriage 40. Further, the carriage 40 supports the control board 45 and the head cover 48.

In the present embodiment, the head 20 and the sub-tank 30 are fixed to the carriage 40 with adhesive. Note that the head 20 may be non-detachably fixed to the carriage 40. Here, the term "non-detachably" means a state where the head 20 cannot be easily detached from the carriage 40. For example, the head 20 and the carriage 40 are connected firmly to such an extent that in a case where the head 20, which is fixed to the carriage 40 with adhesive, is being detached from the carriage 40, the head 20 or the carriage 40 is more likely to be damaged. Further, a special tool is needed to detach, from the carriage 40, the head 20 which is fixed to the carriage 40 with, for example, a screw.

Two holes 41 and 42 are defined in the carriage 40, as illustrated in FIG. 13B. The two holes 41 and 42 are defined at a location, in a bottom surface 40A of the carriage 40, which is to the front of a part, of the carriage 40, in which the head 20 is accommodated. The two holes 41 and 42 are positioning holes for positioning the belt-retained part 70 with respect to the carriage 40. The hole 41 is large enough so that a projection 73, which will be described later, of the belt-retained part 70 can be inserted into the hole 41. The hole 42 is large enough so that a projection 74, which will be described later, of the belt-retained part 70 can be inserted into the hole 42. An opening 43 which opens downward is defined in the carriage 40. The opening 43 exposes the entirety of the nozzle surface 20A, of the head 20 accommodated in the carriage 40, downward.

The carriage 40 has two sliders 44A and 44B, as illustrated in FIGS. 4B and 13B. The slider 44A is disposed in a lower part of a front end of the carriage 40, and is disposed on the guide rail 14. The slider 44A has two slider parts 44A1 and 44A2 which are spaced apart from each other in the left-right direction.

The slider 44B is disposed in a lower part of a rear end of the carriage 40, and is disposed on the guide rail 13. The slider 44B has a slider part 44B1 longer than the slider part 44A1 in the left-right direction.

The sub-tank 30 is disposed on the head 20 as illustrated in FIG. 5. The sub-tank 30 has four ink channels 31 inside the sub-tank 30. The inks of mutually different colors are supplied, respectively, to the four ink channels 31.

FIG. 5 illustrates one channel 31 among the four ink channels 31. The ink channel 31 has a supply port 31A at an upper end of the ink channel 31, and a discharge port 31B at a lower end of the ink channel 31. The Ink channel 31 further has a horizontal part 31C extending horizontally, and a vertical part 31D extending downward from the horizontal part 31C. The supply port 31A is open in an upper surface 30A of the sub-tank 30. The discharge port 31B is open in a lower surface 30B of the sub-tank 30.

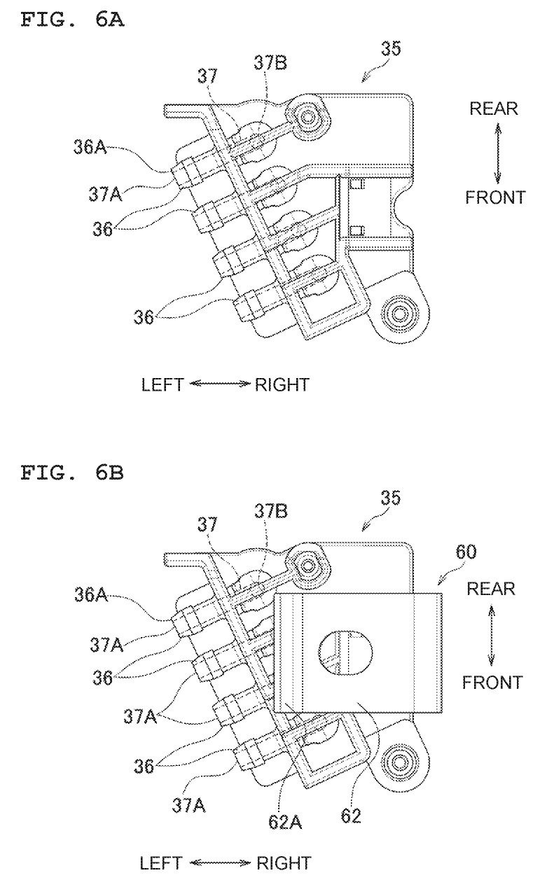

The joint member 35 has four connecting parts 36 and four connecting channels 37, as illustrated in FIGS. 6A and 6B. Since the structures of the four connecting parts 36 are the same as one another and the structures of the four connecting channels 37 are the same as one another, one connecting part 36 among the four connecting channels 36 and a connecting channel 37, among the four connecting channels 37, which corresponds to the one connecting part 36 will be described. The connecting part 36 has a cylindrical shape, and the other end of the ink tube 7 is connected to the connecting part 36. A part of the connecting channel 37 is disposed within the connecting part 36. The connecting channel 37 has a supply port 37A at one end of the connecting channel 37, and a discharge port 37B at the other end of the connecting channel 37.

The supply port 37A is disposed at a tip surface 36A of the connecting part 36. The discharge port 37B is open in a lower surface 35A (see FIG. 5), of the joint member 35, which faces the upper surface 30A of the sub-tank 30.

The head unit 2 has a retaining member 60 which locks the joint member 35, as illustrated in FIGS. 4A and 6B. The joint member 35 is disposed in a state where each of the four discharge ports 37B faces the supply port 31A of a corresponding one of the four ink channels 31. In this situation, the retaining member 60 presses the joint member 35 against the sub-tank 30 from above. With this, the joint member 35 is detachably retained with respect to the sub-tank 30. Thus, the four connecting channels 37 allows the four ink channels 31 to communicate with the four ink tubes 7, respectively. The details of the retaining member 60 will be described later.

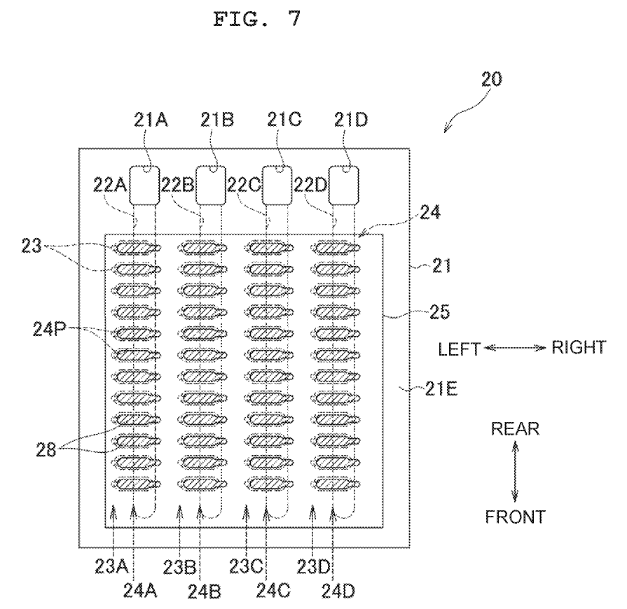

The head 20 has a channel unit 21, and an actuator unit 25, as illustrated in FIGS. 5 and 7. The channel unit 21 has four common channels 22, a plurality of nozzles 23, and a plurality of individual channels 24. The four common channels 22 extend in the front-rear direction and are disposed side by side in the left-right direction. The four common channels 22 are referred to as common channels 22A to 22D, in some cases, in order from the left to the right in FIG. 7.

Four supply ports 21A to 21D are open in an upper surface 21E of the channel unit 21. The four supply ports 21A to 21D are disposed side by side in the left-right direction at a rear end part of the upper surface 21E. The supply port 21A communicates with the common channel 22A. The supply port 21B communicates with the common channel 22B. The supply port 21C communicates with the common channel 22C. The supply port 21D communicates with the common channel 22D. The supply ports 21A to 21D communicate with the discharge port 31B, and the ink of mutually different colors are supplied to the supply ports 21A to 21D, respectively.

The plurality of nozzles 23 are open in the nozzle surface 20A. The plurality of nozzles 23 are arranged in four nozzle rows 23A to 23D. Nozzles 23, of the plurality of nozzles 23, are aligned in the front-rear direction in each of the nozzle rows 23A to 23D.

The plurality of individual channels 24 are arranged in four individual channel rows 24A to 24D. Individual channels, of the plurality of individual channels 24, are aligned in the front-rear direction in each of the individual channel rows 24A to 24D. One end of each of the plurality of individual channels 24 communicates with a corresponding one of the nozzles 23, and the other end of each of the plurality of individual channels 24 communicates with one of the common channels 22. Each of the plurality of individual channels 24 has a pressure chamber 24P. The pressure chamber 24P has an oval shape which is long in the left-right direction, and is open in the upper surface 21E of the channel unit 21.

Each of the individual channels 24 belonging to the individual channel row 24A communicates with a corresponding one of the nozzles 23 belonging to the nozzle row 23A and with the common channel 22A. Each of the individual channels 24 belonging to the individual channel row 24B communicates with a corresponding one of the nozzles 23 belonging to the nozzle row 23B and with the common channel 22B. Each of the individual channels 24 belonging to the individual channel row 24C communicates with a corresponding one of the nozzles 23 belonging to the nozzle row 23C and with the common channel 22C. Each of the individual channels 24 belonging to the individual channel row 24D communicates with a corresponding one of the nozzles 23 belonging to the nozzle row 23D and with the common channel 22D. The plurality of nozzles 23 eject the mutually different color inks from the nozzle rows 23A to 23D, respectively. More specifically, yellow, cyan, magenta, and black inks are ejected in order from the leftmost nozzle row 23A to the rightmost nozzle row 23D in FIG. 7.

The actuator unit 25 is disposed in the upper surface 21E of the channel unit 21, as illustrated in FIGS. 5 and 7. The actuator unit 25 includes a vibration plate 26, two piezoelectric layers 27A and 27B, a plurality of individual electrodes 28, and a common electrode 29. The piezoelectric layer 27A is the upper layer with respect to the piezoelectric layer 28B.

The vibration plate 26 is joined to the upper surface 21E of the channel unit 21 in a state where the vibration plate 26 covers the pressure chamber 24P of each of the plurality of individual channels 24. The two piezoelectric layers 27A and 27B are stacked on the upper surface of the vibration plate 26. Each of the plurality of individual electrodes 28 is disposed in the upper surface of the piezoelectric layer 27A, as the upper layer, and faces the pressure chamber 24P of a corresponding one of the plurality of individual channels 24. The common electrode 29 is disposed across the pressure chambers 24P of the plurality of individual channels 24, at a location between the two piezoelectric layers 27A and 27B.

Each of the plurality of individual electrodes 28 and the common electrode 29 are connected to the control board 45 via the COF 47. The driver IC 46 is mounted on the COF 47. The control board 45 is connected to the controller 80 via the wiring member 8. The common electrode 29 is maintained at the ground potential.

Upon receiving a signal from the controller 80, the driver IC 46 supplies a drive signal to the individual electrodes 28. With this, a part, of the piezoelectric layer 27A as the upper layer, facing the pressure chamber 24P is piezoelectrically deformed, thereby deforming the vibration plate 26 to bend. In this situation, the volume of the pressure chamber 24P changes, thereby applying pressure to the ink in the individual channel 24, and ejecting the ink from the nozzle 23.

The control board 45 is disposed above the sub-tank 30, as illustrated in FIGS. 4A and 5. The control board 45 has an electronic component and a plurality of wires. Further, the control board 45 has a first region 45A and a second region 45B. The first region 45A is covered by the head cover 48 except for a front end part of the first region 45A, and although the entirety of the first region 45A is not illustrated in the drawings, the first region 45A has a rectangular shape in plan view which is long in the front-rear direction and covers most of a region, of the sub-tank 30, which overlaps the head 20 in the up-down direction.

The second region 45B is a region extending from a front left end part of the first region 45A obliquely forward to the left. The sensor 92 is supported on the lower surface of a front end part of the second region 45B. The sensor 92 is electrically connected to a connector 45C via the plurality of wires of the control board 45.

Further, the connector 45C is supported on an upper surface 45A1 of the first region 45A. The connector 45C is disposed at the front end part of the first region 45A. Further, the COF 47 and the sensor 93 are connected to the first region 45A of the control board 45. Since the COF 47 is covered by the head cover 48, the COF 47 is not illustrated in FIG. 4A. The COF 47 and the sensor 93 are electrically connected to the connector 45C via the plurality of wires of the control board 45. The upper surface 45A1 of the present embodiment corresponds to the surface of the control board, on which the first connector is supported" of the present disclosure.

The connector 45C of the present embodiment is a plug-type connector. A connector 9C, which will be described later, is moved downward from a location above the connector 45C toward the connector 45C, thereby causing the connector 45C to mate with the connector 9C. With this, the connector 45C is electrically connected to the connector 9C.

On the other hand, the connector 9C, which is mated with the connector 45C, is moved upward with respect to the connector 45C, and thus the mating of the connector 9C with the connector 45C is released. As a result, the electrical connection between the connector 45C and the connector 9C is released. The connector 45C of the present disclosure corresponds to the "first connector" of the present disclosure, and the connector 9C of the present disclosure corresponds to the "second connector" of the present disclosure. The up-down direction crossing the upper surface 45A1 on which the connector 45C is supported corresponds to the "first direction" of the present disclosure.

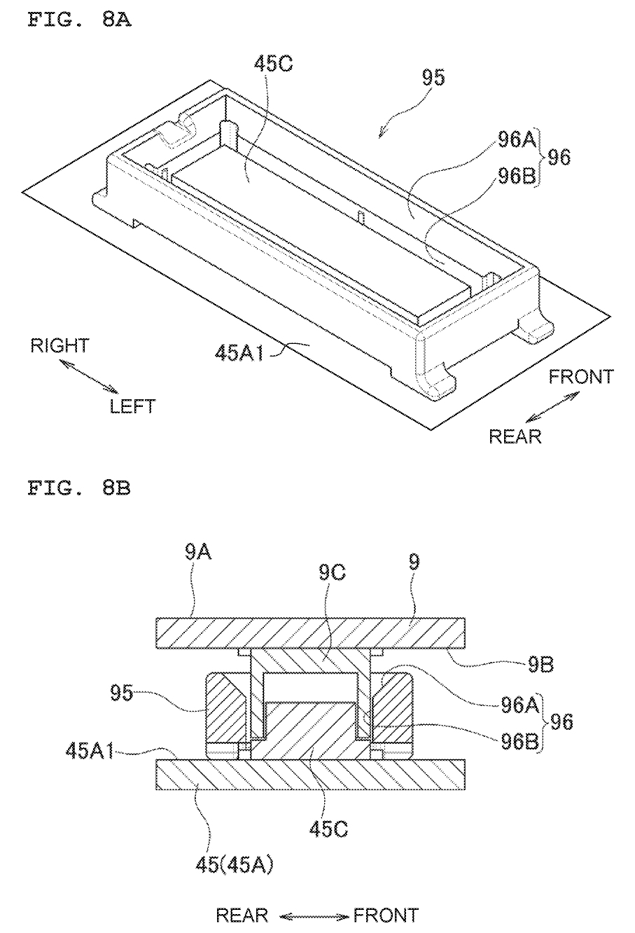

The control board 45 has a guide member 95 supported on the upper surface 45A1 of the first region 45A, as illustrated in FIG. 8A. The guide member 95 has a square cylindrical shape. The guide member 95 has a rectangular shape, in plan view, which is long in the left-right direction. The connector 45C is disposed inside the guide member 95. In other words, the guide member 95 surrounds the entire periphery of the connector 45C.

Note that the guide member 95 may be configured not to surround the entire periphery of the connector 45C, and may be disposed so that only a part of the guide member 95 is disposed adjacent to the connector 45C. Further, a part, of the guide member 95, which surrounds the connector 45C may be discontinuous. In other words, the guide member 95 may surround the periphery of the connector 45C discontinuously.

An inner peripheral surface 96 of the guide member 95 has an upper inner peripheral surface 96A and a lower inner peripheral surface 96B, as illustrated in FIGS. 8A and 8B. The upper inner peripheral surface 96A is inclined further toward the connector 45C as the upper inner peripheral surface 96A extends downward. The lower inner peripheral surface 96B extends downward from the lower end of the upper inner peripheral surface 96A. The lower inner peripheral surface 96B is spaced apart from and faces the side surfaces of the connector 45C in the front-rear and left-right directions. The front-rear direction of the present embodiment corresponds to the "second direction" in claim 3 and the left-right direction of the present embodiment corresponds to the "second direction" in claim 4. The upper inner peripheral surface 96A of the present embodiment corresponds to the "inclined surface, of the guide member, facing the plug-type connector in the second direction" of the present disclosure.

The head cover 48 is configured to cover a part, of the carriage 40, from above, the part being disposed to the rear of the center in the front-rear direction in the carriage 40. Further, the head cover 48 covers the entirety of a part, of the control board 45, the part being disposed to the rear of the connector 45C in the front-rear direction.

The head cover 48 of the present embodiment covers a part of a region different from another region, in the upper surface 45A1 of the control board 45, the connector 45C and the guide member 95 being disposed in the another region. However, the head cover 48 may be configured to be capable of covering, in the upper surface 45A1 of the control board 45, the entirety of the region different from the another region in which the connector 45C and the guide member 95 are disposed. In other words, the head cover 48 may be configured to cover the upper surface 45A1 of the control board 45 so as to expose only the connector 45C and guide member 95 from the head cover 48.

The head cover 48 has a projection 48B projecting upward from the upper surface 48A, as illustrated in FIG. 4A. The projection 48B extends in the left-right direction. The projection 48B is disposed at a front end part, of the head cover 48, and is also disposed at the center in the left-right direction of the head cover 48. The upper surface 48A of the present embodiment is the surface, of the head cover 48, which is opposite the lower surface, of the head cover 48, which faces the upper surface 45A1 of the control board 45. That is, the upper surface 48A corresponds to the "surface, of the cover, which is opposite to another surface, of the cover, which faces the surface of the control board".

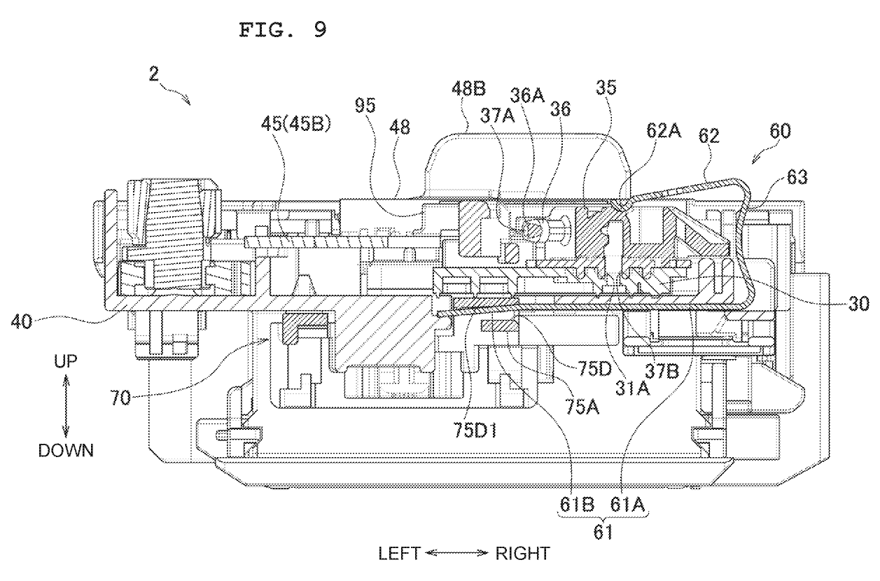

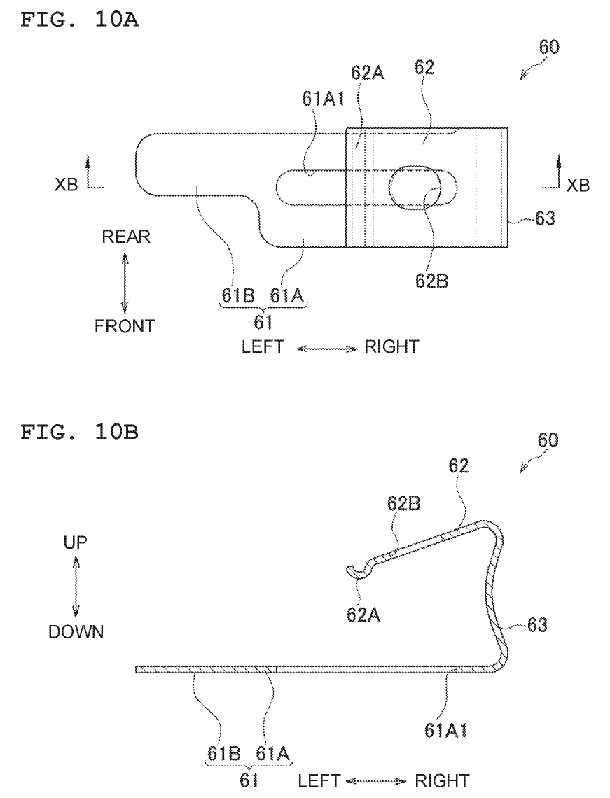

Next, the retaining member 60 and the belt-retained part 70 will be described. The retaining member 60 detachably locks the head unit 2 with respect to the belt-retained part 70, as illustrated in FIGS. 4A and 9. The retaining member 60 has a lower plate part 61, an upper plate part 62, and a linking plate part 63, as illustrated in FIGS. 10A and 10B. The retaining member 60 is elastic. Specifically, the retaining member 60 is configured such that, in response to an external and upward force being applied to the left end of the upper plate part 62, the retaining member 60 is elastically deformable so that the distance in the up-down direction between the lower plate part 61 and the left end of the upper plate part 62 becomes larger than the above-described distance illustrated in FIG. 10B.

The lower plate part 61 is a plate-shaped part extending in the leftward direction from the lower end of the linking plate part 63, as illustrated in FIG. 10B. The upper plate part 62 is a plate-shaped part extending from the upper end of the linking plate part 63 obliquely downward to the left. The lower plate part 61 and the upper plate part 62 are spaced apart from each other in the up-down direction. Further, the lower plate part 61 and the upper plate part 62 face each other in the up-down direction, as illustrated in FIG. 10A.

The lower plate part 61 has a wide part 61A and a narrow part 61B. The wide part 61A has a width in the front-rear direction which is greater than the narrow part 61B. The wide part 61A has a length in the left-right direction which is longer than the narrow part 61B. Since the narrow part 61B is smaller in width than the wide part 61A, the narrow part 61B is more flexible than the wide part 61A.

A hole 61A1 extends through the wide part 61A in the up-down direction. The hole 61A1 has a shape which is long in the left-right direction. A projection 40B (see FIG. 4B) projecting from the bottom surface 40A of the carriage 40 fits into the hole 61A1. Further, the carriage 40 has a support bar 40C extending in the front-to-rear direction at a front right end part of the carriage 40, as illustrated in FIG. 13B. The support bar 40C is disposed with respect to the bottom surface 40A so that a gap, through which the bottom plate part 61 is passed, is defined between the support bar 40C and the bottom surface 40A. With this, as illustrated in FIG. 13B, even in a case where the retaining member 60 is moved to the right from a retention state which will be described later, the left end of the hole 61A1 is engaged with the projection 40B, while the wide part 61A is supported between the bottom surface 40A and the support bar 40C. With this, the retaining member 60 is less likely to be disengaged from the head unit 2.

The upper plate part 62 has a curved part 62A and a hole 62B. The curved part 62A is configured so that a left end part of the upper plate part 62 is curbed to bulge downward. The hole 62B is defined in a center part in the left-right direction of the upper plate part 62 and extends through the upper plate part 62 in the thickness direction of the upper plate part 62. The linking plate part 63 is a plate-shaped part extending in the up-down direction. The linking plate part 63 is slightly curbed so that a central part in the up-down direction of the linking plate part 63 bulges leftward.

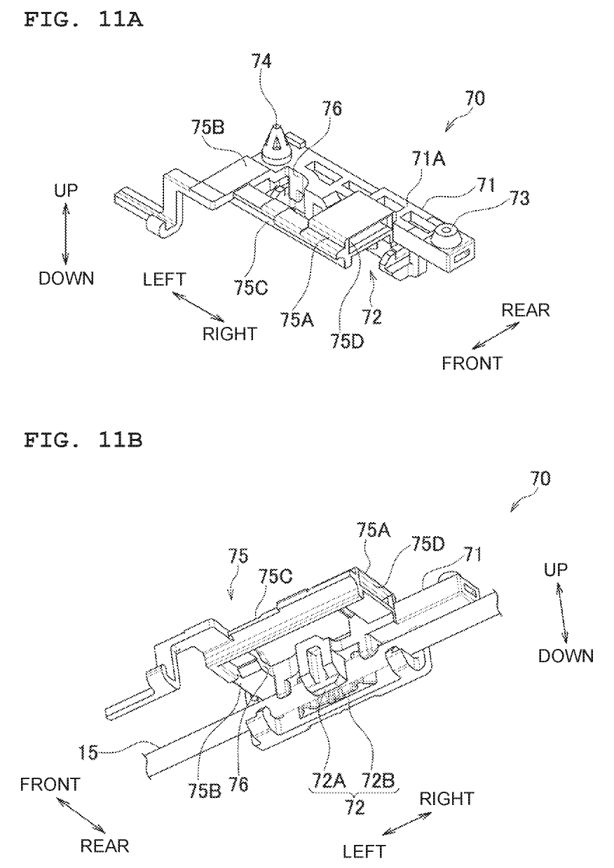

The belt-retained part 70 has a body part 71 and a holding part 72, as illustrated in FIG. 11. The body part 71 extends in the left-right direction, and has two projections 73 and 74 in an upper surface 71A. The projection 73 has a conical trapezoidal shape projecting upward from a right end part of the body part 71. The projection 73 is configured to be insertable into the hole 41 of the carriage 40 illustrated in FIG. 13B. The projection 74 has a conical trapezoidal shape projecting upward from a left end part of the body part 71. The projection 74 has a projection amount which is larger than the projection 73 and a thinner tip than the projection 73. The projection 74 is configured to be insertable into the hole 42 of the carriage 40. As a result, when the belt-retained part 70 is being positioned with respect to the carriage 40, the projection 74 is easily inserted into the hole 42 before the projection 73 is inserted into the hole 41.

Further, the belt-retained part 70 has a frame part 75 in a front side surface of the body part 71. The frame part 75 has a right connecting part 75A, a left connecting part 75B, and a linking part 75C. The frame part 75 has a U-shape in plane view. The right connecting part 75A and the left connecting part 75B extend parallel to each other in the front-rear direction and are spaced apart from each other in the left-right direction. The rear ends of the right connecting part 75A and the left connecting part 75B are connected to the body part 71. The linking part 75C extends in the left-right direction and links the front end of the right connecting part 75A to the front end of the left connecting part 75B. A through part 76 is defined in a region enclosed by the frame part 75 and the body part 71, and extends through the region in the up-down direction.

A hole 75D is defined in the right connecting part 75A, and extends through the right connecting part 75A in the left-right direction. The hole part 75D has a dimension into which the narrow part 61B of the retaining member 60 is insertable. A ceiling surface 75D1 defining the upper part of the hole 75D of the right connecting part 75A is inclined obliquely downward as the ceiling surface 75D extends leftward, as illustrated in FIG. 9. The narrow part 61B of the retaining member 60 is inserted into the hole 75D, as illustrated in FIG. 4B. Then, as illustrated in FIG. 9, the narrow part 61B and the ceiling surface 75D1 engage, and the narrow part 61B flexes downward. In this situation, the narrow part 61B of the lower plate part 61 attempts to return to the original state of the narrow part 61, and thus the belt-retained part 70 is pressed against the bottom surface 40A of the carriage 40. As a result, the belt-retained part 70 is retained with respect to the carriage 40 while being positioned with respect to the carriage 40 by the two projections 73 and 74.

The holding part 72 has a front part 72A and a rear part 72B, as illustrated in FIG. 11B. The front part 72A and the rear part 72B face each other in the front-rear direction. Further, the front part 72A and the rear part 72B hold the belt 15 between the front part 72A and the rear part 72B, thereby retaining the belt-retained part 70 with respect to the belt 15.

Next, the cover 3 will be described in detail. The cover 3 has a cover body 3A and a holding part 3B, as illustrated in FIG. 2. The cover body 3A covers the front end part of the first region 45A of the control board 45 illustrated in FIG. 4A, from above. More specifically, the cover body 3A covers the front end part of the first region 45A, and covers the connector 45C, the guide member 95, and the entire periphery of the connector 45C and the guide member 95. Note that the cover body 3A may be configured to cover either the connector 45C, or a part, of the first region 41A, surrounding the connector 45C. The part, of the first region 41A, surrounding the connector 45C may surround the entire periphery or a partial periphery of the connector 45C. Further, the cover body 3A covers the entirety of the second region 45B from above.

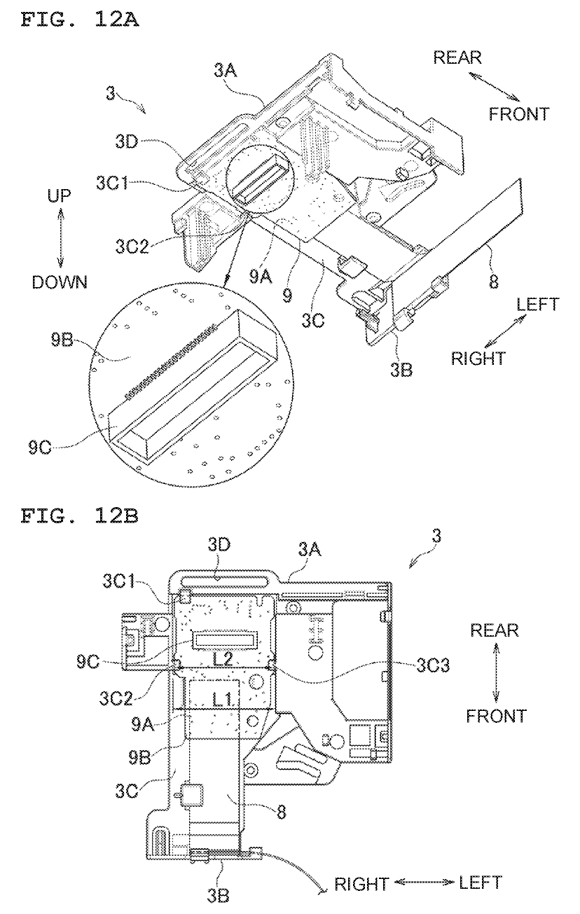

The holding part 3B extends downward from the front end of the cover body 3A, as illustrated in FIG. 12A. The holding part 3B holds the wiring member 8 in a bent state. A part, of the wiring member 8, which extends in the left-right direction is bent at the holding part 3B and caused to extend rearward. The rear end of the wiring member 8 is connected to an upper surface 9A of the relay board 9.

The cover body 3A has three support pieces 3C1 to 3C3 in the lower surface 3C. The support piece 3C1 is disposed at a right rear end part of the cover body 3A. A rear end part of the support piece 3C1 projects upward and is connected to the lower surface 3C. In other words, the remaining part, of the support piece 3C1, different from the rear end part of the support piece 3C1, is spaced apart from the lower surface 3C.

The support piece 3C2 is disposed at the right end of the cover body 3A, and at a location slightly to the rear of the center in the front-rear direction of the cover body 3A. A right end part of the support piece 3C2 projects upward and is connected to the lower surface 3C. In other words, the remaining part, of the support piece 3C2, different from the right end part of the support piece 3C2, is spaced apart from the lower surface 3C. The support piece 3C3 is disposed at the center in the left-right direction of the cover body 3A. A left end part of the support piece 3C3 projects upward and is connected to the lower surface 3C. In other words, the remaining part, of the support pieces 3C3, different from the left end part of the support piece 3C3, is spaced apart from the lower surface 3C.

The rear end part, the right end part and the left end part of the relay board 9 are disposed between the three support pieces 3C1to 3C3 and the lower surface 3C. With this, the relay board 9 is supported by the three support pieces 3C1 to 3C3. A distance L1 between the support pieces 3C2 and 3C3 is greater than a distance L2 between both ends of a part, of the relay board 9, which is supported by the support pieces 3C2 and 3C3, as illustrated in FIG. 12B. The distance L1 is a distance between a connection location at which the support piece 3C2 and the lower surface 3C are connected and a connection location at which the support piece 3C3 and the lower surface 3C are connected in the left-right direction. With this, the relay board 9 is supported to be movable in the left-right direction by the three support pieces 3C1 to 3C3.

Further, the relay board 9 is urged rearward by the wiring member 8 connected to the relay board 9. Therefore, the rear end of the relay board 9 is urged by the wiring member 8 toward the connection location at which the support piece 3C1 and the lower surface 3C are connected. The wiring member 8 is flexible. Accordingly, the relay board 9 is supported to be movable also in the front-rear direction by the three support pieces 3C1 to 3C3.

The relay board 9 has a rectangular shape in plan view which is long in the front-rear direction, as illustrated in FIGS. 12A and 12B. The relay board 9 has the connector 9C supported on a lower surface 9B. The connector 9C is supported by the cover 3 via the relay board 9. Further, the relay board 9 has a plurality of wires connecting the connector 9C and the wiring member 8.

The connector 9C of the present embodiment is a socket-type connector which is open downward. The connector 9C mates with the connector 45C to thereby electrically connect the wiring member 8 with the control board 45. In other words, the driver IC 46 and the two sensors 92 and 93 are electrically connected to the controller 80 via the control board 45 and the wiring member 8.

A through hole 3D extends through a rear end part of the cover body 3A. The through hole 3D is defined side by side with the relay board 9 in the front-rear direction. The through hole 3D has a long and narrow shape in the left-right direction. Further, the through hole 3D is configured so that the convex part 48B is insertable into the through hole 3D, as illustrated in FIG. 2. The cover 3 of the present embodiment has a color different from the color of the head cover 48. With this, the user is able to easily distinguish the cover 3 from the head cover 48 when the user is performing an operation of attaching and detaching the head unit 2. Further, the user is able to easily perform the operation of attaching and detaching the connector 9C to and from the connector 45C while holding the cover 3.

The operation of attaching and detaching the head unit 2 to and from the moving mechanism 4 will be described as follows. In a case where the head unit 2 is to be attached to and detached from the moving mechanism 4, the head unit 2 is located at a position illustrated in FIG. 1. Specifically, the head unit 2 is located at the leftmost position in the guide rails 13 and 14.

The head unit 2 is normally attached to the moving mechanism 4. In other words, the head unit 2 is in a retention state in which the head unit 2 is retained with respect to the belt-retained part 70 by the retaining member 60. Further, in a case where the retaining member 60 is in the retention state in which the retaining member 60 locks the head unit 2 with respect to the belt-retained part 70, a distance in the up-down direction between the lower plate part 61 and the left end of the upper plate part 62 in the retaining member 60 is larger than the above-described distance illustrated in FIG. 10B. In other words, in a case where the retaining member 60 is in the retention state, an elastic return force is generated so that the distance in the up-down direction between the lower plate part 61 and the left end of the upper plate part 62 becomes small. As a result, the joint member 35 is pressed against the sub-tank 30, from above, by the curved part 62A of the upper plate part 62. Thus, in a case where the retaining member 60 is in the retention state, the retaining member 60 locks the head unit 2 with respect to the belt-retained part 70, and retains the joint member 35 with respect to the sub-tank 30.

In this situation, the head unit 2 is covered by the cover 3, and the connector 9C is attached to the connector 45C. In other words, the control board 45 is electrically connected to the wiring member 8.

In order to detach the head unit 2 from the moving mechanism 4, the wiring member 8 is to be first detached from the head unit 2. In the operation of detaching the wiring member 8, the user holds the cover 3 by hand and moves the cover 3 upward. This causes the relay board 9 to move upward together with the cover 3. In this situation, the mating between connector 9C and the connector 45C is released. As a result, the electrical connection between the connector 45C and the connector 9C is released. Thus, as illustrated in FIG. 4A, the cover 3, the relay board 9 and the wiring member 8 are detached from the head unit 2. The cover 3, the relay board 9 and the wiring member 8 remain in the body 1A.

In such a configuration that the wiring member 8 cannot be easily detached from the control board 45, the wiring member 8 needs to be removed from the body 1A when the head unit 2 is to be detached. The wiring member 8 is long and is routed in a complicated manner inside the body 1A. Therefore, removing the wiring member 8 from the body 1A is difficult. Note that routing the removed wiring member 8 in the body 1A and attaching the wiring member 8 to the body 1A is also difficult. In the present embodiment, since the wiring member 8 is configured to be attachable to and detachable from the control board 45, any operation of attaching and detaching the wiring member 8 to and from the body 1A is not performed in the present embodiment.

Next, the user moves the retaining member 60 illustrated in FIG. 4 by hand to the rightward direction, as illustrated in FIG. 13A. With this, the pressing of the joint member 35 against the sub-tank 30 by the retaining member 60 is released. Therefore, the four ink tubes can also be detached from the head unit 2, together with the joint member 35.

Further, in this situation, the narrow part 61B of the retaining member 60 is pulled out from the hole 75D, as illustrated in FIG. 4B. Therefore, in response to the head unit 2 being lifted upward from the moving mechanism 4, the belt-retained part 70 is detached from the carriage 40, as illustrated in FIG. 13B. In other words, the head unit 2 can be detached from the moving mechanism 4 in a state where the belt-retained part 70 is retained with respect to the belt 15, as illustrated in FIG. 14. The head cover 48 of the head unit 2 has the projection 48B. With this, when the head unit 2 is to be detached from the moving mechanism 4, the user can easily grasp the head unit 2 by placing his or her fingers on the tip of the projection 48B and the front or rear end of the carriage 40. Thus, the user can easily operate the head unit 2. In such a manner, the operation of detaching the head unit 2 from the moving mechanism 4 is completed.

The head unit 2 detached from the moving mechanism 4 includes, for example, the head 20, the sub-tank 30, the carriage 40, the control board 45, the head cover 48, and the two sensors 92 and 93. Therefore, by simply replacing the head unit 2 with a new or repaired head 2, the two sliders 44A and 44B of the carriage 40, the two sensors 92 and 93, and even the control board 45 can be replaced as well.

In a case where the head unit 2 is to be attached to the moving mechanism 4, the head unit 2 is placed on the belt-retained part 70 in the state illustrated in FIG. 14. In this situation, the projections 73 and 74 of the belt-retained part 70 are inserted into the holes 41 and 42, respectively, of the carriage 40. Also in a case where the user operates the head unit 2 as described above, the user can grasp the head unit 2 by placing his/her fingers on the tip of the projection 48B of the head cover 48 and the front or rear end of the carriage 40. With this, the user can easily operate the head unit 2, and can easily position the head unit 2 with respect to the belt-retained part 70.

Next, the joint member 35 to which the four ink tubes 7 are connected is disposed on the sub-tank 30. Specifically, the user causes the four discharge ports 37B of the joint member 35 to face the four supply ports 31A, respectively, of the sub-tank 30. Then, the user moves, by hand, the retaining member 60 illustrated in FIG. 13 to the leftward direction, as illustrated in FIG. 4A.

By moving the retaining member 60 to the leftward direction, the retaining member 60 presses the joint member 35 against the sub-tank 30. Accordingly, the four ink tubes are connected to the head unit 2, together with the joint member 35.

Further, in this situation, the narrow part 61B of the retaining member 60 is inserted into the hole 75D. With this, the belt-retained part 70 is pressed against the bottom surface 40A of the carriage 40. Accordingly, the belt-retained part 70 is retained with respect to the carriage 40 while being positioned with respect to the carriage 40 by the two projections 73 and 74. In such a manner, the head unit 2 is attached to the moving mechanism 4. The head unit 2 is located at the left ends of the guide rails 13 and 14. Therefore, even in a case where the retaining member 60 is moved to the leftward direction, the head unit 2 does not move leftward. Therefore, the user is able to easily attach the retaining member 60 to the head unit 2 while pressing the joint member 35 and the belt-retained part 70 against the head unit 2.

Next, the user performs the operation of attaching the wiring member 8 to the head unit 2. The operation of attaching the wiring member 8 is performed as follows: first, the user holds the cover 3 by hand and inserts the projection 48B of the head cover 48 into the through hole 3D of the cover 3. This enables rough positioning of the cover 3 with respect to the head unit 2. Note that the relay board 9 to which the wiring member 8 is connected is supported on the cover 3.

Next, the user moves the cover 3 downward, and causes the connector 9C to mate with the connector 45C to thereby attach the connector 9 to the connector 45. In this situation, the connector 9C is supported, via the relay board 9, to be movable in the front-rear and left-right directions with respect to the cover 3. Therefore, when the user causes the connector 9C to mate with the connector 45C, the center of the connector 9C and the center of the connector 45C are easily coincident. Therefore, the connector 9C can be easily attached to the connector 45C.

Further, also in a case where the user causes the connector 9C to mate with the connector 45C, the lower end of connector 9C is guided by the upper inner peripheral surface 96A of the guide member 95, even if the center of the connector 9C and the center of the connector 45C are slightly deviated in the front-rear direction or the left-right direction. Owing to the above-described guiding, the relay board 9 moves, together with the connector 9C, in the front-rear and left-right directions with respect to the cover 3, thereby easily causing the center of the connector 9C and the center of the connector 45C to coincide with each other. Accordingly, the connector 9C can be easily attached to the connector 45C. In the present embodiment, the downward direction in a case where the connector 9C approaches the connector 45C corresponds to the "direction of relative approach" of the present disclosure.

The control board 45 of the head unit 2 is electrically connected to the controller 80 via the wiring member 8. In this manner, the operation of attaching the wiring member 8 to the head unit 2 is completed, and the operation of attaching the head unit 2 to the moving mechanism 4 is also completed.

As described above, the cover 3 covers the part of the control board 45 in a state where the connector 9C is attached to the connector 45C, as illustrated in FIG. 2. More specifically, the cover 3 covers the front end part of the first region 45A and the entirety of the second region 45B. With this, the configuration can be realized in which, when the user attaches and detaches the head unit 2 to and from the moving mechanism 4, the user is able to hold the cover 3 with his or her hand and to attach and detach the connector 9C to and from the connector 45C. With this, the hand of the user is less likely to come into contact with the control board 45 during the operation of attaching and detaching the wiring member 8 to and from the head unit 2. As a result, the control board 45 is less likely to be damaged.

The cover 3 supports the connector 9C via the relay board 9. With this, the hand of the user is less likely to come into contact also with the relay board 9 during the operation of attaching and detaching the wiring member 8 to and from the head unit 2.

The cover 3 supports the connector 9C to be movable in the front-rear and left-right directions. With this, the connector 9C can be easily attached to the connector 45C. Any attachment error of the connector 9C with respect to the cover 3 can be tolerated.

The guide member 95 is disposed adjacent to the connector 45C. With this, the connector 9C can be easily attached to the connector 45C. Further, the guide member 95 surrounds the entire periphery of the connector 45C. With this, the connector 9C can be attached to the connector 45C more easily. Note that even in a case where the guide member 95 discontinuously surrounds the periphery of the connector 45C, the connector 9C can be attached to the connector 45C more easily.

The head cover 48 covers the entirety of the part, of the control board 45, the part being disposed to the rear of the connector 45C, in the front-rear direction. With this, the hand of the user is less likely to come into contact with the control board 45 during the operation of attaching and detaching the wiring member 8 to and from the head unit 2.

The head cover 48 has the projection 48B. Therefore, the user can grasp the projection 48B so as to operate the head unit 2. Therefore, the head unit 2 can be easily operated.

The through hole 3D through which the projection 48B is passable is defined in the cover 3. With this, in a case where the connector 9C is being attached to the connector 45C, the projection 48B is caused to pass through the through hole 3D to thereby easily attach the connector 9C to the connector 45C.

The carriage 40 has the two sliders 44A and 44B. With this, by simply replacing the head unit 2, the carriage 40 including the two sliders 44A and 44B is also replaced. With this, any decrease in the movement accuracy of the head 20, which might be otherwise caused due to, for example, wear of the sliders 44A and 44B, can be prevented.

Further, the head unit 2 has the two sensors 92 and 93. With this, simply by replacing the head unit 2, the two sensors 92 and 93 are also replaced. With this, any decrease in the accuracy in the detection of the moving position of the head unit 2, which might be otherwise caused due to, for example, deterioration or contamination of the sensor 92, can be prevented. Further, any decrease in the accuracy in the detection of the width of the sheet S in the left-right direction, which might be otherwise caused due to, for example, the deterioration or contamination of the sensor 93, can be prevented.

As described above, according to the printer 1 of the present embodiment, the operation of attaching and detaching the head unit 2 to and from the moving mechanism 4 can be performed by simply attaching and detaching the head unit 2 to and from the belt-retained part 70. Therefore, any operation of slackening the belt and detaching the belt from the pulley, and of adjusting the tension of the belt after attaching the belt to the belt-retained part 70 is not necessary. As a result, the operation of attaching and detaching the head unit 2 can be performed easily.

The head 20 accommodated in the carriage 40 is non-detachably fixed to the carriage 40. With this, any assembly error is less likely to occur between the head 20 and the carriage 40. Provided that in a configuration in which a replaced head 20 can be attached to the carriage 40, the head 20 might be attached to the carriage 40 while being deviated from the carriage 40. In the configuration of the present embodiment, however, the head 20 is not deviated from the carriage 40 even when the operation of attaching and detaching the head unit 2 is performed.

The retaining member 60 detachably locks the head unit 2 with respect to the belt-retained part 70. In this case, the necessity to secure the accuracy in attaching the head unit 2 with respect to the belt-retained part 70 is low, as compared to a configuration in which the head unit 2 is directly retained with respect to the belt-retained part 70 without using the retaining member 60. Further, the retaining member 60 detachably locks the joint member 35 with respect to the sub-tank 30. With this, the same retaining member 60 can be used to hold the joint member 35 with respect to the sub-tank 30 and to retain the head unit 2 with respect to the belt-retained part 70, thus reducing the number of parts and operations for the retainment.

The retaining member 60 holds the belt-retained part 70 between the lower plate part 61 and the head unit 2 to thereby detachably retain the head unit 2 with respect to the belt-retained part 70. Further, the retaining member 60 holds the joint member 35 between the upper plate part 62 and the sub-tank 30 to thereby detachably retain the joint member 35 with respect to the sub-tank 30. With this, the joint member 35 can be retained with respect to the sub-tank 30, and the head unit 2 can be retained with respect to the belt-retained part 70, with the retaining member 60 having a simple shape.

The retaining member 60 which is in the released state is moved in the leftward direction to transition to the retention state, and the retaining member 60 which is in the retention state is moved in the rightward direction to transition to the release state. With this, the retaining member 60 can be selectively switchable between the retention state and the released state, simply by being moved with respect to the head unit 2 parallel to the left-right direction.

The lower plate part 61 and the upper plate part 62 of the retaining member 60 face each other in the up-down direction. With this, the size of the retaining member 60 can be reduced in the front-rear direction.

For example, in a case where the user uses a retaining member having a switching part which is switchable between the retention state and the released state and which is disposed above the head unit 2, so that the user can operate the above-described retaining member from above the head unit 2, the switching part raises the center of gravity of the head unit. In a case where the center of gravity of the head unit is raised, the head unit is more likely to tilt to the left or to the right when the head unit is being moved in the left-right direction. As a result, the printing might be affected such that the quality of an image recorded on a sheet S is lowered. However, in the configuration of the present disclosure, the center of gravity of the head unit 2 is less likely to be raised since the retaining member 60, which is elastically deformable, is used. Therefore, the printing is less likely to be affected, as compared with the above-described case, and the quality of an image recorded on the sheet S is maintained during the printing.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the head unit 2 in the above-described embodiment is of the serial type which is movable in the left-right direction, the head unit 2 may also be of the line type which is not movable in the left-right direction. In the head unit of the line type, the head unit is mounted in a head support frame serving as the support part. Further, when the user detaches or attaches the head unit, the user holds the cover 3 by hand and detaches or attaches the connector 9C from or to the connector 45C. Accordingly, during an operation of detaching and attaching the wiring member 8 from and to the head unit, the hand of the user is less likely to come into contact with the control board 45. As a result, the control board 45 is less likely to be damaged.

Further, the head unit 2 may be configured not to include the carriage 40. Further, the head unit 2 may be configured not to include the sub-tank 30.

Furthermore, the attachment and detachment direction between the connector 45C and the connector 9C may be a direction crossing the up-down direction, as long as the direction crosses the upper surface 45A1. Moreover, the connector 9C may also be directly connected to the wiring member 8. In this case, the relay board 9 may be omitted.

The cover 3 may support the connector 9C so that the connector 9C is not movable. The guide member 95 may be omitted.

The head cover 48 may be omitted. The head cover 48 may be configured without having the projection 48B. In this case, the cover 3 may be configured without having the through hole 3D. The head cover 48 and the cover 3 may be of the mutually same color.

The carriage 44 may be configured without having the sliders 44A and 44B. The head unit 2 may be configured without having the sensors 92 and 93.

The retaining member 60 of the above-described embodiment may be configured such that the retaining member 60 does not perform both the retention of the head unit 2 with respect to the belt-retained part 70 and the retention of the head unit 2 with respect to the joint member 35, in combination. The printer 1 may have another retaining member which holds the head unit 2 with respect to the joint member 35.

Further, the retaining member 60 may have any shape as long as the retaining member 60 is able to retain the head unit 2 with respect to the belt-retained part 70. The linking plate part 63 may extend in a direction which crosses the front-rear, left-right and up-down directions.

Furthermore, the retaining member 60 may be configured to be selectively switchable between the retention state and the release state by being moved in a direction which crosses the left-right direction. In such a case, a direction in which the lower plate part 61 and the upper plate part 62 extend from the linking plate part 63 may also be the direction which crosses the left-right direction. Further, the lower plate part 61 and the upper plate part 62 may be configured not to face each other in the up-down direction.

Moreover, the joint member 35 may be non-detachably fixed to the head unit 2.

Further, the moving mechanism 4 may have two, three, or five or more pulleys. Furthermore, the moving mechanism 4 may be configured without having the guide rails 13 and 14.

The printer 1 may be configured such that a socket-type connector 9C is supported on the upper surface 45A1 of the control board 45 and that a plug-type connector 45C is supported on the lower surface 9B of the relay board 9. In this case, the guide member 95 may be supported on the lower surface 9B of the relay board 9 so as to surround the connector 45C.

The printer 1 may record an image on a recording medium other than the sheet S. The recording medium is not limited to the paper, and may be constructed of any material, such as cloth or plastic film.

The head 20 may eject, as the recording material, a liquid other than ink, such as a processing liquid which agglomerates or precipitates a component in an ink.

The present disclosure is not limited to the printer, and is applicable also to facsimiles, copy machines, multi-function peripherals, etc.

What is claimed is:

1. An image recording apparatus comprising:
a head unit including a head, and a control board having a controller configured to control the head;
a support part configured to detachably support the head unit;
a wiring member;
a cover;
a first connector supported on the control board; and
a second connector connected to the wiring member, the second connector being detachable from the first connector in a first direction crossing a surface, of the control board, on which the first connector is supported,
wherein the cover is configured to support the second connector, and
in a state where the second connector is attached to the first connector, the cover is configured to cover at least a part of the control board.

2. The image recording apparatus according to claim 1, wherein
the wiring member is a flexible flat cable,
the image recording apparatus further comprises a relay board to which the flexible flat cable is connectable,
the relay board supports the second connector, and
the cover is configured to support the relay board.

3. The image recording apparatus according to claim 1, wherein
the cover supports the second connector to be movable in a second direction crossing the first direction.

4. The image recording apparatus according to claim 1, wherein
one of the first connector and the second connector is a plug-type connector,
the other of the first connector and the second connector is a socket-type connector,
the image recording apparatus further comprises:
a guide member disposed adjacent to the plug-type connector in a second direction crossing the first direction, the guide member being configured to guide the socket-type connector as the socket-type connector is being attached to the plug-type connector, wherein the guide member has an inclined surface facing the plug-type connector in the second direction when the socket-type connector is attached to the plug-type connector.

5. The image recording apparatus according to claim 4, wherein
the guide member surrounds the plug-type connector.

6. The image recording apparatus according to claim 1, wherein
the head unit further includes a head cover configured to cover a region of the surface of the control board, different from another region, of the surface of the control board, at which the first connector is disposed.

7. The image recording apparatus according to claim 6, wherein
the head cover has a projection in a surface, of the cover, which is opposite to another surface, of the cover, which faces the surface of the control board.

8. The image recording apparatus according to claim 7, wherein
a through hole is defined in the cover, the projection passing the through hole in the first direction when the second connector is being attached to the first connector.

9. The image recording apparatus according to claim 6, wherein
the head cover and the cover have different colors, respectively.

10. The image recording apparatus according to claim 1, wherein
the support part includes a guide rail, and constructs a moving mechanism configured to move the head unit along the guide rail,
the head unit includes a carriage which holds the control board, and
the carriage has a slider which is movable along the guide rail on the guide rail.

11. The image recording apparatus according to claim 1, wherein
the support part includes a guide rail, and constructs a moving mechanism configured to move the head unit along the guide rail, and
the head unit includes a sensor connected to the control board.
